(19) United States
(12) Patent Application Publication
(10) Pub. No.: US 2023/0353489 A1
(43) Pub. Date: Nov. 2, 2023

(54) Systems and Methods for Managing Network Switches

(71) Applicant: Arista Networks, Inc., Santa Clara, CA (US)

(72) Inventors: Aaron Payment, Coquitlam (CA); Eddie Kibicho, Vancouver (CA); Jeff Jing Yuen Chan, Burnaby (CA); Joshua Portelance, Kamloops (CA); Michael Nelson, North Vancouver (CA)

(21) Appl. No.: 17/731,043

(22) Filed: Apr. 27, 2022

(51) Int. Cl. H04L 45/28; G06F 13/28; H04L 45/00; H04L 47/12

(52) U.S. Cl. CPC H04L 45/28; G06F 13/28; H04L 45/22; H04L 47/12

(57) ABSTRACT

Embodiments of the present disclosure include a switch processor programming agent to establish a logical interface to multiple switch processors in a network device. Feature agents for performing operations on a plurality of switch processors received configuration data. The switch processor programming agents translate the configuration data from a first format to a second format and program multiple switch processors in the second format. Switch processors may be switch ASICs for routing network traffic. In one embodiment, a switch processor and a redundant switch processor are maintained in the same state by the switch processor programming agent for seamless transition to the redundant switch processor when the other switch processor becomes inoperable.

### BACKGROUND

The present disclosure relates generally to data networks and network devices, and in particular, to systems and methods for managing network switches.

Data networks often comprise numerous network devices connected together to move data between various sources and destinations. Managing the operation of such networks can be a challenge. Maintaining uptime in a network is often imperative, and when various network devices become inoperable, traffic must be rerouted quickly to prevent loss of service.

One common network device is a network switch. A network switch may interconnect many sources and destinations of network traffic. A typical switch may include many switch processors, each having at least one input port and output port to send and receive data over a wired connection. However, when a switch processor becomes inoperable, there may be a corresponding interruption in the flow of data through the card.

The present disclosure presents an innovative technique for managing switches and other resources in a network device to reduce downtime, for example.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions.

FIG. 1 illustrates a system for managing switches according to an embodiment.

FIG. 2 illustrates a method of managing switches in a network device according to an embodiment.

FIG. 3A illustrates an example system for managing switches according to one embodiment.

FIG. 3B illustrates an example system for managing switches according to another embodiment.

FIG. 4 illustrates software components for managing switches according to another embodiment.

FIG. 5 illustrates an example network device according to another embodiment.

FIG. 6 depicts another example network device according to an embodiment.

FIG. 7 depicts a simplified block diagram of an example computer system according to certain embodiments.

### DETAILED DESCRIPTION

Described herein are techniques for managing components of a network device. In the following description, for purposes of explanation, numerous examples and specific details are set forth in order to provide a thorough understanding of some embodiments. Some embodiments as defined by the claims may include some or all of the features in these examples alone or in combination with other features described below, and may further include modifications and equivalents of the features and concepts described herein.

Features and advantages of the present disclosure include techniques for managing components of a network device. A network device may comprise multiple of the same components, such as switches. It may be desirable for software to interface with one software component, which in turn programs multiple components of the network device. For example, multiple switch processors may be programmed by a switch processor programming agent. The switch processor programming agent may be a single point of interface for software used to program the switch processors.

Embodiments of the present disclosure may include a switch processor programming agent to establish a logical interface to multiple switch processors in a network device. Feature agents for performing operations on a plurality of switch processors receive configuration data. The switch processor programming agents translate the configuration data from a first format to a second format and program multiple switch processors in the second format. Switch processors may be switch ASICs for routing network traffic. In one embodiment, a switch processor and a redundant switch processor are maintained in the same state by the switch processor programming agent for seamless transition to the redundant switch processor when the other switch processor becomes inoperable.

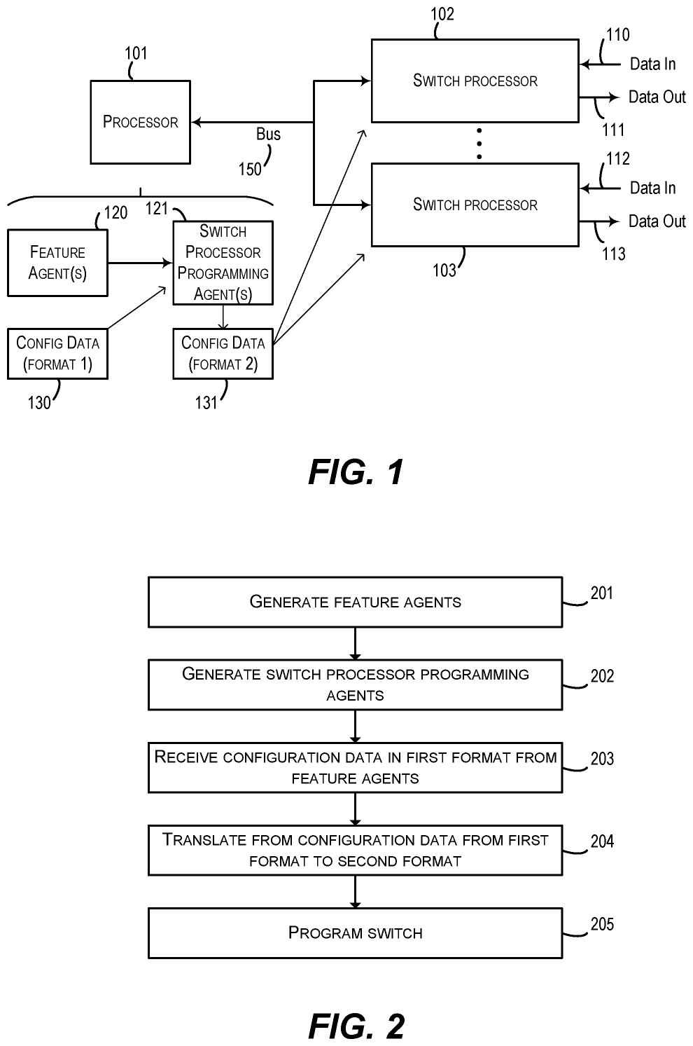

FIG. 1 illustrates a system for managing switches according to an embodiment. In various embodiments, a plurality of switch processors 102-103 may be programmed by software executing on a processor 101 over data bus 150. Switch processor 102-103 may comprise a plurality of ports 110-113 for establishing connections to other sources and destinations of data.

Processor 101 may generate feature agents 120. Feature agents 120 may comprise code for managing particular features of switch processors 102-103. Feature agents 120 may program related sets of features into switch processors 102-103. For example, a feature agent may comprise logic for controlling mirroring in a switch processor (e.g., copying traffic from one port to another port). Another feature agent may comprise logic for configuring a layer 2 media access controller (L2 MAC) in a switch processor (e.g., L2 Ethernet tables) or layer 3 internet protocol (IP) tables. Yet another feature agent may comprise logic for configuring virtual local area network (VLAN) translations. A variety of feature agents may be used to perform other tasks on switch processors 102-103.

Typically, control and configuration software may be required to interface directly with each switch processor, which may require such software to include switch processor specific logic and information. Advantageously, certain embodiments of the present disclosure include one or more switch processor programming agents 121, which may comprise a logical representation of the switch processor (e.g., a virtual representation of the physical hardware in the switch processors). Switch processor programming agents 121 may act as an interface for one or more feature agents to program multiple switch processors 102-103, for example, such that the feature agents may be unaware of the physical hardware in the switch processors. Switch processor programming agents 121 may store switch state information (e.g., configuration data) for a plurality of switch processors 102-103 to program multiple switch processors into the same state, for example.

Switch processor programming agents 121 may receive configuration data from feature agents 120 in a first format. The configuration data may comprise a table of data in one of the feature agents in a first format, such as in an intermediate level programming language format (e.g., C++) or the like. Switch processor programming agents 121 translate the configuration data into a second format, which may be used to program the switch processor. The second format may be a hardware specific format for directly programming circuits (e.g., particular registers) in the switch processors, for example. For instance, a table of data in a feature agent used to specify a particular operation of the switch processor may be converted to a table of data in another format. The translated data may be used to program switch processors 102-103 to carry out the particular operation. Switch processor programming agents 121 may automatically program a plurality switch processors with the configuration data in the second format. For example, in one embodiment, the configuration data may be converted to a direct memory access (DMA) format, and a switch processor programming agent 121 executing on processor 101 may perform a direct memory access (DMA) write to switch processors 102 and 103 over data bus 150, for example.

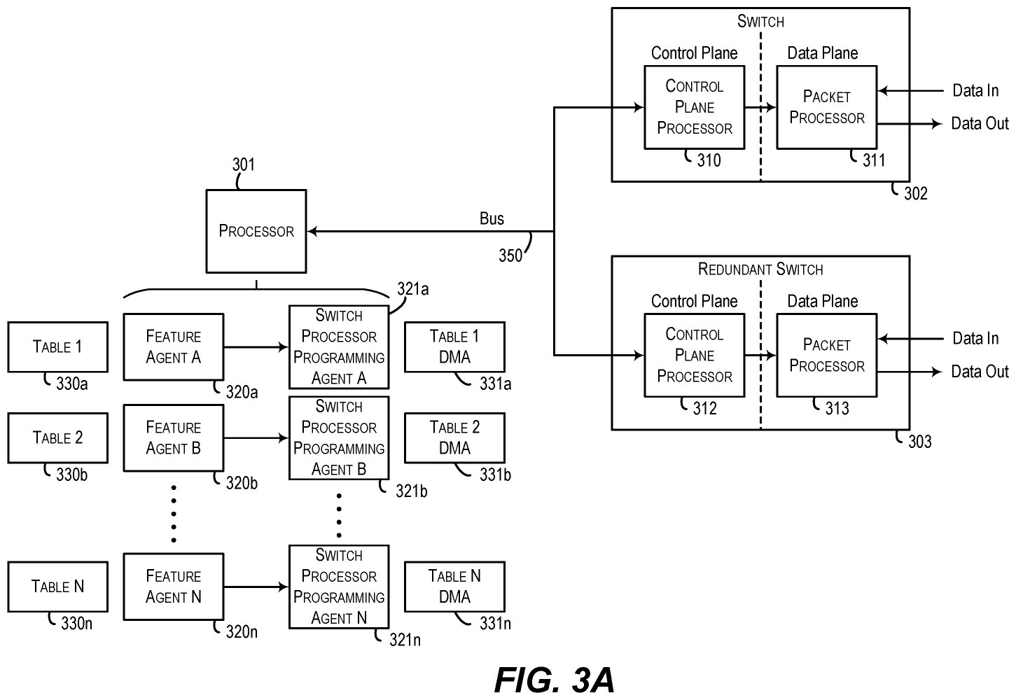

FIG. 2 illustrates a method of managing switches in a network device according to an embodiment. At 201, one or more feature agents are generated on a processor. The feature agents may be software components executing on the processor to carry out particular operations on a switch processor, such as mirroring, VLAN operations, or L2 MAC configurations, for example. At 202, one or more switch processor programming agents are generated on the processor. Switch processor programming agents may provide a single logical interface for configuring multiple switch processors. As described in more detail below, a feature agent may have a corresponding switch processor programming agent, which may be customized to provide an interface for the particular configurations and operations controlled by the feature agent, for example. In another embodiment, multiple feature agents may interface with the same switch processor programming agent. At 203, configuration data is received by the switch processor programming agents in a first format from a corresponding one or more feature agents. At 204, the switch processor programming agents translate the plurality of configuration data into a second format. At 205, the switch processor programming agents program the plurality switch processor with the configuration data in the second format.

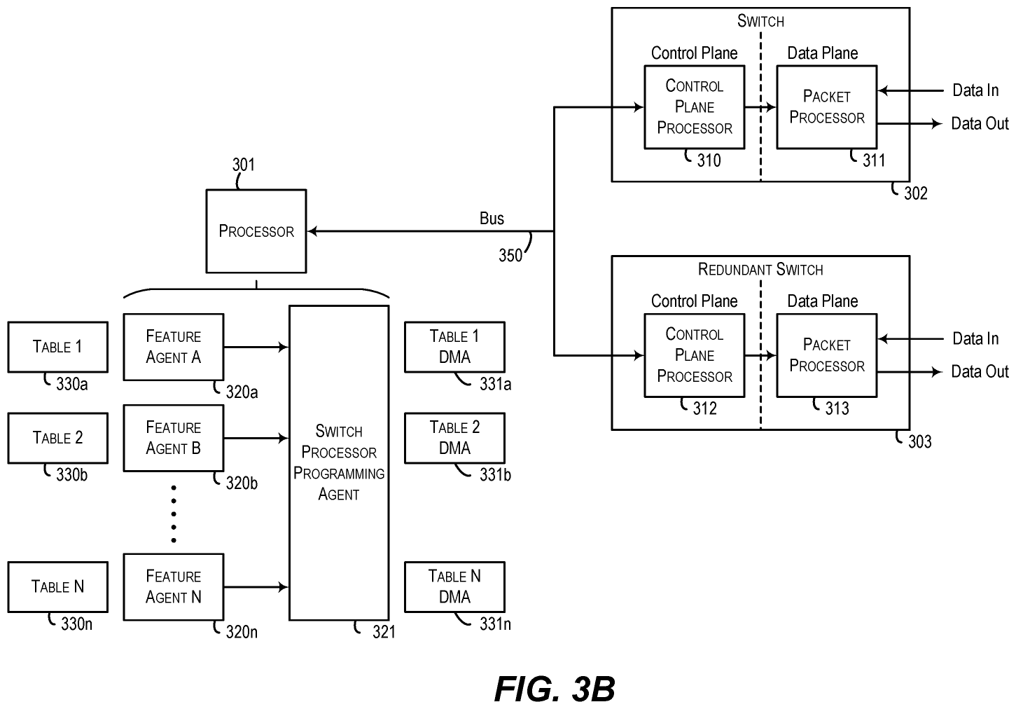

FIG. 3A illustrates an example system for managing switches according to one embodiment. In this example, a processor 301 may be coupled to two or more switches, such as switch 302 and a redundant switch 303 (e.g., these can include redundant switches in separate chassis or redundant switchcards (or linecards) within the same chassis). In this example, switch 302 may be the active switch routing network traffic and redundant switch 303 may be inactive. However, switches 302 and 303 may be maintained in the same state so that if switch 302 becomes inoperable, redundant switch 303 may quickly take over routing network traffic.

In this illustrative example, switches 302 and 303 comprise control plane processors 310 and 312 and packet processors 311 and 313, respectively. Packet processors 311/313 route network traffic (e.g., across a “data plane”) and are examples of switch processors. Control plane processors 310/312 are used to configure, control, and otherwise manage the operation of the packet processors 311/313 (e.g., from a “control plane”) and provide an interface for network administration, for example.

Processor 301 may execute a plurality of feature agent software components 320a-n. In this example, each feature agent 320a-n controls a particular aspect of the packet processors 311/313 and has a corresponding switch processor programming agent 321a-n to program the hardware in packet processors 311/313. For instance, feature agent 320a may receive Table 1 330a comprising configuration logic for a particular feature of packet processors 311/313 (e.g., mirroring). Switch processor programming agent A 321a may be an interface for feature agent 320a to packet processors 311/313 and convert the logic (code) in table 1 330a to a direct memory access (DMA) format 331a. Processor 301 may signal control plane processors 310 and 312 that a DMA transaction is to occur, and processor 301 may write the DMA code into both packet processor 311 and 313 (e.g., simultaneously) so that both packet processors are in the same state. Similarly, other feature agents 320b-n may receive configuration data (e.g., Tables 2-N 330b-n) and corresponding switch processor programming agents 321b-n translate the configuration logic to DMA format to configure packet processors 311 and 313 in the same state. In this example, feature agents working with corresponding customized switch processor programming agents may result in reduced latency in programming the switch processors given the potentially large volumes of configuration data that may be programmed for all the different feature agents.

FIG. 3B illustrates an example system for managing switches according to another embodiment. In this example, multiple different feature agents 320a-n interface with packet processors 311/313 using the same switch processor programming agent 321. Accordingly, a plurality of feature agents 320a-n send configuration data 330a-n in the first format to a single switch processor programming agent 321 to produce configuration data 331a-n in a DMA format to program different features and operations of packet processors 311/313, for example.

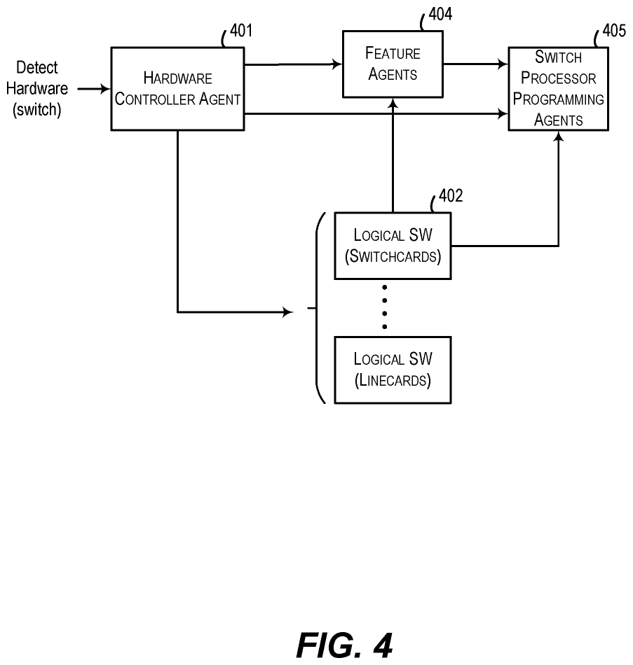

FIG. 4 illustrates software components for managing switches according to another embodiment. Here, a hardware controller agent 401 detects the presence of physical components of network devices, such as switches, switchcards, linecards, and the like. Hardware controller agent 401 may execute on processor 100 of FIG. 1, for example. When hardware controller agent 401 detects a switch, it may generate a logical switch object 402, which may be used to represent multiple switches, such as a switch processor and a redundant switch processor or multiple redundant switchcards or linecards, for example. Logical switch objects 402 may signal the presence of at least one resource to feature agents 404 and switch processor programming agents 405. Logical switch objects 402 may specify how many switch processors are connected (e.g., one switch processor and one redundant switch processor), the type of switch processor (e.g., a switch processor or ASIC model), features that need to be configured for a particular type of hardware, specific port types and configurations of the hardware, and the like. When a first switch processor is detected by hardware controller agent 401, a logical switch processor object 402 may be created and used to send setup data to the feature agents 404 and switch processor programming agents 405. When a second redundant switch processor is detected by hardware controller agent 401, the existing logical switch processor object 402 may be updated to indicate that there are two switch processors available. Switch processors and redundant switch processors may have the same model type, and thus all the programming is the same. Thus, switch processor programming agents 405 simply use the same translated configuration data to program both switch processors (e.g., using 2 DMA writes).

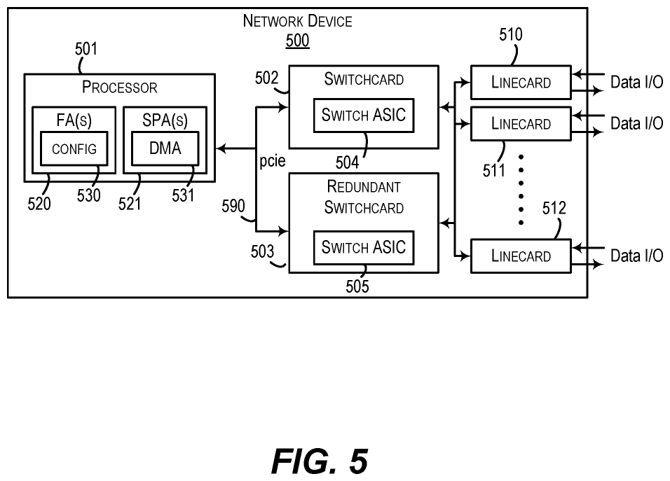

FIG. 5 illustrates an example network device according to another embodiment. In this example, network device 500 comprises two redundant switchcards 502 and 503 and a plurality of linecards 510-512. Network device 500 may include additional pairs of redundant switchcards and linecards (not shown). Processor 501 executes feature agents (FA(s)) 520 that program switch processors 504 and 505 in switchcards 502 and 503 through switch processor programming agents (SPA(s)) 521. In this example, switch processors 504-505 are switch application specific integrated circuits (ASICs) that may have control processor and packet processor functions integrated onto a single semiconductor integrated circuit. FAs 520 receive configuration data 530 and SPAs 521 translate the configuration data into DMA data 531, which may be directly programmed into each switch ASIC 504 and 505 over PCIE bus 590 so that both switch ASICs have the same state and redundant switchcard 503 may become active to route traffic if switchcard 502 becomes inoperable.

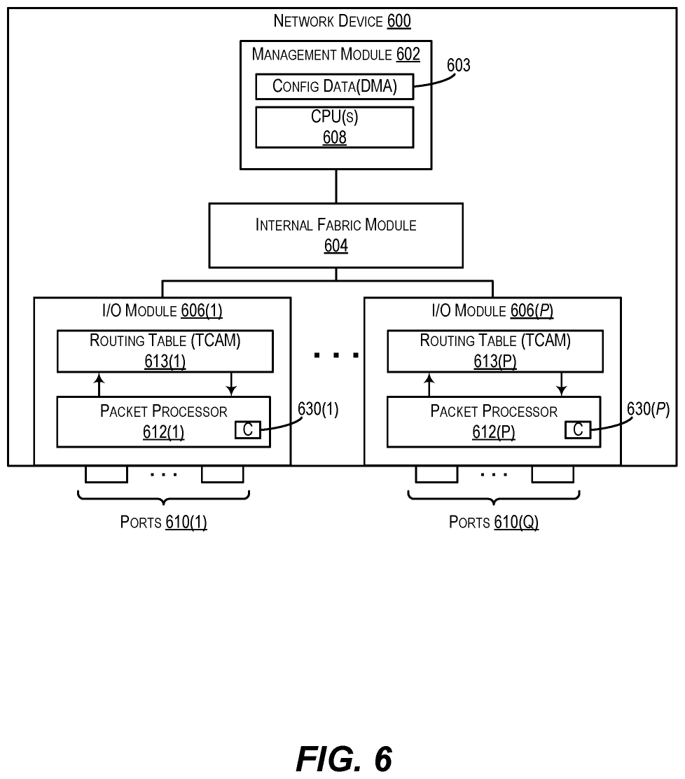

FIG. 6 depicts an example network device (e.g., a network switch) 600 that may be illustrative of a network device in certain embodiments. Example embodiments of network devices may be implemented, at least in part, via one or more ASICs and/or other hardware processing elements.

As shown, network device 600 includes a management module 602, an internal fabric module 604, and a number of I/O modules 606(1)-606(P). Management module 602 includes one or more management CPUs 608 for managing/controlling the operation of the device. Each management CPU 608 can be a general purpose processor, such as an Intel/AMD x86 or ARM-based processor, for example, that operates under the control of software stored in an associated memory (not shown). Management module 602 may receive configuration data 603 (e.g. software executed by CPU 608 or sent to packet processors) as described above.

Internal fabric module 604 and I/O modules 606(1)-606(P) collectively represent the data, or forwarding, plane of network device 600. Internal fabric module 604 is configured to interconnect the various other modules of network device 600. Each I/O module 606(1)-606(P) includes one or more input/output ports 610(1)-610(Q) that are used by network device 600 to send and receive network packets. Each I/O module 606(1)-606(P) can also include a packet processors 612(1)-612(P). Packet processors 612(1)-612(P) are a hardware processing component (e.g., an ASIC) that can make wire speed decisions on how to handle incoming or outgoing network packets. In certain embodiments, translated configuration data 630(1)-(P) may be received within packet processors 612(1)-612(P) to configure the packet processors. In this example, I/O module 606(1)-606(P) further includes a routing table 613(1)-613(P), which may include a content addressable memory (CAM, such as a TCAM).

It should be appreciated that network device 600 is illustrative and many other configurations having more or fewer components than network device 600 are possible.

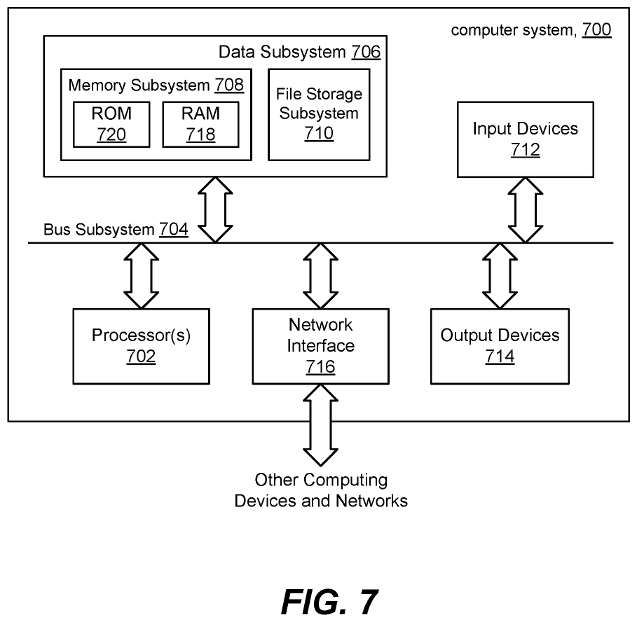

FIG. 7 depicts a simplified block diagram of an example computer system 700 according to certain embodiments. Some or all of the components of computer system 700 may be used in a system including a processor to execute feature agents, switch processor programming agents, and other software components described herein. As shown in FIG. 7, computer system 700 includes one or more processors 702 that communicate with a number of peripheral devices via bus subsystem 704. These peripheral devices include data subsystem 706 (comprising memory subsystem 708 and file storage subsystem 710), user interface input devices 712, user interface output devices 714, and network interface subsystem 716.

Bus subsystem 704 can provide a mechanism that enables the various components and subsystems of computer system 700 to communicate with each other as intended. Although bus subsystem 704 is shown schematically as a single bus, alternative embodiments of the bus subsystem can utilize multiple busses.

Network interface subsystem 716 can serve as an interface for communicating data between computer system 700 and other computer systems or networks. Embodiments of network interface subsystem 716 can include, e.g., an Ethernet card, a Wi-Fi and/or cellular adapter, and the like.

User interface input devices 712 can include a keyboard, pointing devices (e.g., mouse, trackball, touchpad, etc.), a touch-screen incorporated into a display, audio input devices (e.g., voice recognition systems, microphones, etc.) and other types of input devices. In general, use of the term “input device” is intended to include all possible types of devices and mechanisms for inputting information into computer system 700.

User interface output devices 714 can include a display subsystem, a printer, or non-visual displays such as audio output devices, etc. The display subsystem can be, e.g., a flat-panel device such as a liquid crystal display (LCD) or organic light-emitting diode (OLED) display. In general, use of the term “output device” is intended to include all possible types of devices and mechanisms for outputting information from computer system 700.

Data subsystem 706 includes memory subsystem 708 and file/disk storage subsystem 710 represent non-transitory computer-readable storage media that can store program code and/or data, which when executed by processor 702, can cause processor 702 to perform operations in accordance with embodiments of the present disclosure.

Memory subsystem 708 includes a number of memories including main random access memory (RAM) 718 for storage of computer executable instructions and data during program execution and read-only memory (ROM) 720 in which fixed instructions are stored. File storage subsystem 710 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 700 is illustrative and many other configurations having more or fewer components than system 700 are possible.

### FURTHER EXAMPLES

Each of the following non-limiting examples may stand on its own or may be combined in various permutations or combinations with one or more of the other examples.

In one embodiment, the present disclosure includes a method for managing switches in a network device comprising: generating, on a processor, one or more feature agents, the one or more feature agents performing a plurality of operations on a plurality of switch processors; generating, on the processor, one or more switch processor programming agents; receiving, by the one or more switch processor programming agents, a plurality of configuration data in a first format received from a corresponding one or more feature agents; translating, by the one or more switch processor programming agents, the plurality of configuration data into a second format; and automatically programming, by the one or more switch processor programming agents, the plurality switch processors with the configuration data in the second format.

In another embodiment, non-transitory computer-readable storage medium having stored thereon computer executable instructions for performing a method of configuring a network device, wherein the instructions, when executed by said network device, cause said network device to be operable for: generating, on a processor, one or more feature agents, the one or more feature agents performing a plurality of operations on a plurality of switch processors; generating, on the processor, one or more switch processor programming agents; receiving, by the one or more switch processor programming agents, a plurality of configuration data in a first format received from a corresponding one or more feature agents; translating, by the one or more switch processor programming agents, the plurality of configuration data into a second format; and automatically programming, by the one or more switch processor programming agents, the plurality switch processors with the configuration data in the second format.

In another embodiment, the present disclosure includes a network device comprising: a processor; a first switch processor configured to route network traffic; and a second switch processor configured to route network traffic, wherein the processor executes one or more feature agents and one or more switch processor programming agents, wherein the one or more feature agents interface with the first switch processor and the second switch processor through the one or more switch processor programming agents to program the first and second switch processors.

In one embodiment, the one or more switch processor programming agents maintain the plurality of switch processors in a same state.

In one embodiment, the plurality of switch processors comprise a first switch processor that routes network traffic and a second redundant switch processor that does not route network traffic, wherein the second redundant switch processor maintains a same state as the first switch processor, and wherein the second redundant switch processor routes network traffic when the first switch processor becomes inoperable.

In one embodiment, in response to a change in the configuration data in the first format, the switch processor programming agent automatically translates the change in the configuration data from the first format to the second format and automatically programs the plurality of switch processors with the change in the configuration data in the second format.

In one embodiment, the switch processors are switch application specific integrated circuits (ASIC).

In one embodiment, each switch processor is a same processor maintained in a same state.

In one embodiment, the second format is a direct memory access (DMA) format and the one or more switch processor programming agents automatically program the plurality of switch processors using direct memory access (DMA) transactions over a bus coupled between the processor and the plurality of switch processors.

In one embodiment, a first switch processor programming agent accesses a first table of data for a first feature agent, translates the first table of data into a second table of data in a direct memory access (DMA) format, and performs a first direct memory access (DMA) write between the processor and a first switch processor and performs a second direct memory access (DMA) write between the processor and a second switch processor.

In one embodiment, a plurality of feature agents send configuration data in the first format to a single switch processor programming agent.

In one embodiment, a plurality of feature agents send configuration data in the first format to a corresponding plurality of switch processor programming agents.

In one embodiment, the first switch processor routes network traffic and the second switch processor does not route network traffic, wherein the second switch processor maintains a same state as the first switch processor, and wherein the second switch processor routes network traffic when the first switch processor becomes inoperable.

In one embodiment, the one or more switch processor programming agents receive a plurality of configuration data in a first format from a corresponding one or more feature agents and translate the plurality of configuration data into a second format, and wherein the one or more switch processor programming agents automatically program the first and second switch processors with the configuration data in the second format.

The above description illustrates various embodiments along with examples of how aspects of some embodiments may be implemented. Accordingly, the above examples and embodiments should not be deemed to be the only embodiments, and are presented to illustrate the flexibility and advantages of some embodiments as defined by the following claims. Based on the above disclosure and the following claims, other arrangements, embodiments, implementations and equivalents may be employed without departing from the scope hereof as defined by the claims.

What is claimed is:

1. A method for managing switches in a network device comprising:
generating, on a processor, one or more feature agents, the one or more feature agents performing a plurality of operations on a plurality of switch processors;
generating, on the processor, one or more switch processor programming agents;
receiving, by the one or more switch processor programming agents, a plurality of configuration data in a first format received from a corresponding one or more feature agents;
translating, by the one or more switch processor programming agents, the plurality of configuration data into a second format; and
automatically programming, by the one or more switch processor programming agents, the plurality switch processors with the configuration data in the second format.

2. The method of claim 1 wherein the one or more switch processor programming agents maintain the plurality of switch processors in a same state.

3. The method of claim 1 wherein the plurality of switch processors comprise a first switch processor that routes network traffic and a second redundant switch processor that does not route network traffic, wherein the second redundant switch processor maintains a same state as the first switch processor, and wherein the second redundant switch processor routes network traffic when the first switch processor becomes inoperable.

4. The method of claim 1 wherein, in response to a change in the configuration data in the first format, the switch processor programming agent automatically translates the change in the configuration data from the first format to the second format and automatically programs the plurality of switch processors with the change in the configuration data in the second format.

5. The method of claim 1, wherein the switch processors are switch application specific integrated circuits (ASIC).

6. The method of claim 1, wherein each switch processor is a same processor maintained in a same state.

7. The method of claim 1, wherein the second format is a direct memory access (DMA) format and the one or more switch processor programming agents automatically program the plurality of switch processors using direct memory access (DMA) transactions over a bus coupled between the processor and the plurality of switch processors.

8. The method of claim 1, wherein a first switch processor programming agent accesses a first table of data for a first feature agent, translates the first table of data into a second table of data in a direct memory access (DMA) format, and performs a first direct memory access (DMA) write between the processor and a first switch processor and performs a second direct memory access (DMA) write between the processor and a second switch processor.

9. The method of claim 1, wherein a plurality of feature agents send configuration data in the first format to a single switch processor programming agent.

10. The method of claim 1, wherein a plurality of feature agents send configuration data in the first format to a corresponding plurality of switch processor programming agents.

11. A network device comprising:
a processor;
a first switch processor configured to route network traffic; and
a second switch processor configured to route network traffic,
wherein the processor executes one or more feature agents and one or more switch processor programming agents,
wherein the one or more feature agents interface with the first switch processor and the second switch processor through the one or more switch processor programming agents to program the first and second switch processors.

12. The network device of claim 11 wherein the one or more switch processor programming agents maintain the plurality of switch processors in a same state.

13. The network device of claim 11 wherein the first switch processor routes network traffic and the second switch processor does not route network traffic, wherein the second switch processor maintains a same state as the first switch processor, and wherein the second switch processor routes network traffic when the first switch processor becomes inoperable.

14. The network device of claim 11 wherein the one or more switch processor programming agents receive a plurality of configuration data in a first format from a corresponding one or more feature agents and translate the plurality of configuration data into a second format, and wherein the one or more switch processor programming agents automatically program the first and second switch processors with the configuration data in the second format.

15. The network device of claim 14 wherein, in response to a change in the configuration data in the first format, at least one switch processor programming agent automatically translates the change in the configuration data from the first format to the second format and automatically programs the first and second switch processors with the change in the configuration data in the second format.

16. The network device of claim 14 wherein the second format is a direct memory access (DMA) format and the one or more switch processor programming agents automatically program the first and second switch processors using direct memory access (DMA) transactions over a bus coupled between the processor and the first and second switch processors.

17. The network device of claim 11 wherein a first switch processor programming agent accesses a first table of data for a first feature agent, translates the first table of data into a second table of data in a direct memory access (DMA) format, and performs a first direct memory access (DMA) write between the processor and the first switch processor and performs a second direct memory access (DMA) write between the processor and the second switch processor.

18. The network device of claim 11 wherein a plurality of feature agents send configuration data in the first format to a single switch processor programming agent.

19. The network device of claim 11 wherein a plurality of feature agents send configuration data in the first format to a corresponding plurality of switch processor programming agents.

20. A non-transitory computer-readable storage medium having stored thereon computer executable instructions for performing a method of configuring a network device, wherein the instructions, when executed by said network device, cause said network device to be operable for:
generating, on a processor, one or more feature agents, the one or more feature agents performing a plurality of operations on a plurality of switch processors;
generating, on the processor, one or more switch processor programming agents;
receiving, by the one or more switch processor programming agents, a plurality of configuration data in a first format received from a corresponding one or more feature agents;
translating, by the one or more switch processor programming agents, the plurality of configuration data into a second format; and
automatically programming, by the one or more switch processor programming agents, the plurality switch processors with the configuration data in the second format.
